(19) United States
(12) Patent Application Publication
(10) Pub. No.: US 2025/0181975 A1
(43) Pub. Date: Jun. 5, 2025

(54) Machine Learning Systems and Methods for Automatic Detection of Attorney-Client Privilege in Enterprise Data

(71) Applicant: ClearForce, Inc., Vienna, VA (US)

(72) Inventor: Thomas Miller, Fairfax, VA (US)

(73) Assignee: ClearForce, Inc., Vienna, VA (US)

(21) Appl. No.: 18/962,194

(22) Filed: Nov. 27, 2024

Related U.S. Application Data
(60) Provisional application No. 63/604,739, filed on Nov. 30, 2023.

(51) Int. Cl. G06N 20/00

(52) U.S. Cl. CPC G06N 20/00

(57) ABSTRACT

Machine learning systems and methods for automatic detection of attorney-client privilege in enterprise data are provided. The system receives event identifiers associated with an event that may require legal review and/or assertion of attorney-client privilege. The system receives attorney identifiers associated with an attorney assigned to a reviewer role for the event. The system captures communications transmitted by employees across one or more computer networks within the system. The system searches the communications for the one or more event identifiers. If a matching event identifier is discovered in a communication, the system processes the communication by enhancing the communication and then releasing the communication or blocking the communication until reviewed by the attorney.

### RELATED APPLICATIONS

This application claims the priority of U.S. Provisional Application Ser. No. 63/604,739 filed on Nov. 30, 2023, the entire disclosure of which is expressly incorporated herein by reference.

### BACKGROUND

### Field

The present disclosure relates to machine learning systems and methods. More specifically, the present disclosure relates to machine learning systems and methods for automatic detection of attorney-client privilege in enterprise data.

### Related Art

Certain events and employee behaviors can create legally sensitive issues for enterprises. Enterprises often attempt to protect certain internal communication by including inside or outside legal counsel and establishing attorney client privilege. Because multiple departments and individuals are involved in employee matters, and because systems are not centralized or designed to protect privilege, this privilege is often lost because of mistakes with internal processes (e.g., a document is not marked as privileged, is shared outside of an attorney, or is viewed with unauthorized access) or is not held sufficient by a court because of a lack of activity and engagement by the attorney (e.g., attorney rubber stamping).

Events at an enterprise may inadvertently or advertently cause risk to the enterprise. Events can include, but are not limited to, certain employee behavior (e.g., harassment, assault, employee IP theft, etc.) and internal and external incidences (e.g., cyberattacks, data theft, hostile workplace environment, etc.). An event can include a one-time incident (e.g., an assault) or can involve on-going activity (e.g., ongoing litigation). Events may place the enterprise at risk in many ways, including damaging the enterprise's brand, reputation, and name, and compromising the enterprise's intellectual property.

Accordingly, machine learning systems and methods are desirable for automatic detection of communications requiring attorney review and/or attorney-client privilege in enterprises, which addresses the foregoing and other needs.

### SUMMARY

The present disclosure relates to machine learning systems and methods for automatic detection of attorney-client privilege in enterprise data. An event is identified that may require legal review and/or attorney-client privilege. The system receives event identifiers associated with the event. The system receives attorney identifiers associated with an attorney assigned to a reviewer role for the event. The system captures communications transmitted by employees across one or more computer networks within the system. The system searches the communications for the one or more event identifiers. If a matching event identifier is discovered in a communication, the system processes the communication by enhancing the communication and then releasing the communication or blocking the communication until reviewed by the attorney.

### BRIEF DESCRIPTION OF THE DRAWINGS

The foregoing features of the invention will be apparent from the following Detailed Description, taken in connection with the accompanying drawings, in which:

FIG. 1 is a flowchart illustrating processing steps carried out by the systems and methods of the present disclosure;

FIG. 2 is a flowchart illustrating the identification and enhancement steps of the present disclosure in greater detail;

FIG. 3 is a flowchart illustrating attorney input steps carried out by the systems and methods of the present disclosure;

FIG. 4 depicts an illustrative computing network that is used in accordance with embodiments shown and described herein;

FIGS. 5-6 are diagrams illustrating sample hardware and software components which can be utilized to implement the systems and methods of the present disclosure; and

FIG. 7 is a block diagram of an exemplary computing device that may be used to implement example embodiments described herein.

### DETAILED DESCRIPTION

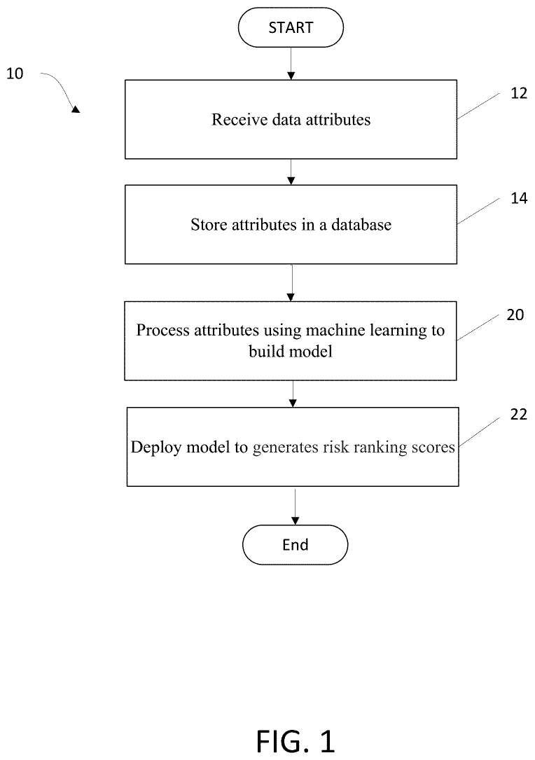

The present disclosure relates to machine learning systems and methods for automatic detection of attorney-client privilege in enterprise data, as discussed in detail below in connection with FIGS. 1-7.

As used herein, an “enterprise” generally refers to any entity that has a plurality of individuals associated therewith. As such, an enterprise may include, but is not limited to, a place of business, a government entity, a charitable enterprise, a financial institution, an educational institution, a medical institution, an interest group, and/or the like. As used herein, “computer networks” are the interconnections of several computers for the sharing of information, resources, software, hardware, and more, within the enterprise. The computer networks may be intranets, extranets, and/or the internet (e.g., a wide area network (WAN), a local area network (LAN), a mobile communications network, a public service telephone network (PSTN), a personal area network (PAN), a metropolitan area network (MAN), a virtual private network (VPN), and/or another network). Additionally, as used herein, “communications” may be e-mails, instant messages, direct messages, file transfers, messages within chat rooms, voice calling, videos, documents, internet searches, web browsing, and the like. In some embodiments, communications further include metadata that describes and gives information about the communications.

Further, an “employee” as used herein generally relates to an individual that is not only employed by an enterprise, but is also associated with an enterprise in such a manner as to have access to the enterprise's proprietary information, which may include, but is not limited to, an owner, a member, an elected official, a volunteer, a contractor, an authorized individual, a teacher, a student, an agent and/or the like. The employee may come in contact with, or have access to, resources owned and/or operated by the enterprise, networked or standalone computers, buildings owned and/or occupied by the enterprise, tangible goods owned by the enterprise, funds, data, intellectual property, and/or the like.

FIG. 1 is a flowchart illustrating processing steps carried out by the systems and methods of the present disclosure, indicated generally at 10. In step 12, an event is identified that may require legal review and/or attorney-client privilege. For example, an employee, such as an administrative or analyst, identifies an event that may require legal review and/or attorney-client privilege. In some embodiments, machine learning is used to analyze communications transmitted over the networks of the system and identify events that may require legal review and/or attorney-client privilege

In step 14, the system receives one or more event identifiers. For example, the employee enters the event identifiers relating to the event into the system via a graphical user interface communicatively coupled to the system. The event identifiers include information associated with the event. For example, the event identifiers can include, but are not limited to, names associated with the event, email addresses of individuals associated with the event, addresses associated with the event, and phone numbers associated with the event. In some embodiments, the event identifiers can include a summary of the event. The employee can further specific whether communications including the event identifiers transmitted over the networks should be enhanced and released or blocked until reviewed by the attorney, as described herein at step 22. For example, an event of a more serious nature may require all communications associated with that event to be reviewed by an attorney. The event identifiers are entered into the graphical user interface and stored in one or more databases (e.g., relational database, object database, etc.). The one or more databases are accessed by the system.

In step 16, the system receives one or more attorney identifiers associated with an attorney assigned to a reviewer role for the event. For example, the employee enters the attorney identifiers into the system via the graphical user interface communicatively coupled to the system. The attorney identifiers are stored in the one or more databases in association with the event. The attorney identifiers can include, but are not limited to, a name of an attorney and an email address for the attorney. The attorney can be internal (e.g., an in-house attorney) or external (e.g., an outside attorney) to the enterprise.

In step 18, the system captures communications transmitted by employees across one or more computer networks within the system. Generally this occurs while employees are logged into an enterprise's networks and/or using an electronic device (such as a computing device, a mobile device, or the like) that is owned and/or maintained by an enterprise, and digital data of the communications is transmitted across the networks. In some embodiments, the enterprise uses network firewalls (e.g., a hardware firewall and/or software firewall) and router logs to capture communications sent over the networks. In additional embodiments, the enterprise uses network analyzers to capture communications sent over the networks. In additional embodiments, the enterprise uses advanced monitoring tools such as packet-sniffers or packet capturers to capture communications sent over the networks. In additional embodiments, the enterprise uses specific software, such as e-mail monitoring software or a filter, to capture communications sent over the networks. In some embodiments, the enterprise may utilize all or a combination of the above.

In step 19, the system saves the communication in a database. In some embodiments, the system allows a user to conduct one or more searches through saved communications using one or more search combinations. For example, the user can search using one or more (or combinations of) the following queries: names, telephone number, postal code, address, city, and any other suitable queries.

In step 20, the system searches the communications for one or more event identifiers. For example, in some embodiments, the system searches names and/or email addresses in e-mails to determine whether names and/or email addresses in the e-mails may match event identifiers. In some embodiments, the system uses a matching algorithm (e.g., an exact matching algorithm, fuzzy matching algorithm, etc.) to identify strings within the communication that matches event identifiers. In additional embodiments, the system uses machine learning algorithms to determine whether the communication includes event identifiers. For example, the machine learning algorithms may use statistical models to classify data and determine whether words or a sequence of words found in a communication match or are close to any words of the event identifiers.

In step 22, the system determines whether a communication includes an event identifier. That is, a determination may be made as to whether one or more event identifiers have been detected in the communication. If an event identifier is not detected in the communication, the system releases the communication in step 24. For example, in the case of an e-mail, the system releases the e-mail to the original recipients.

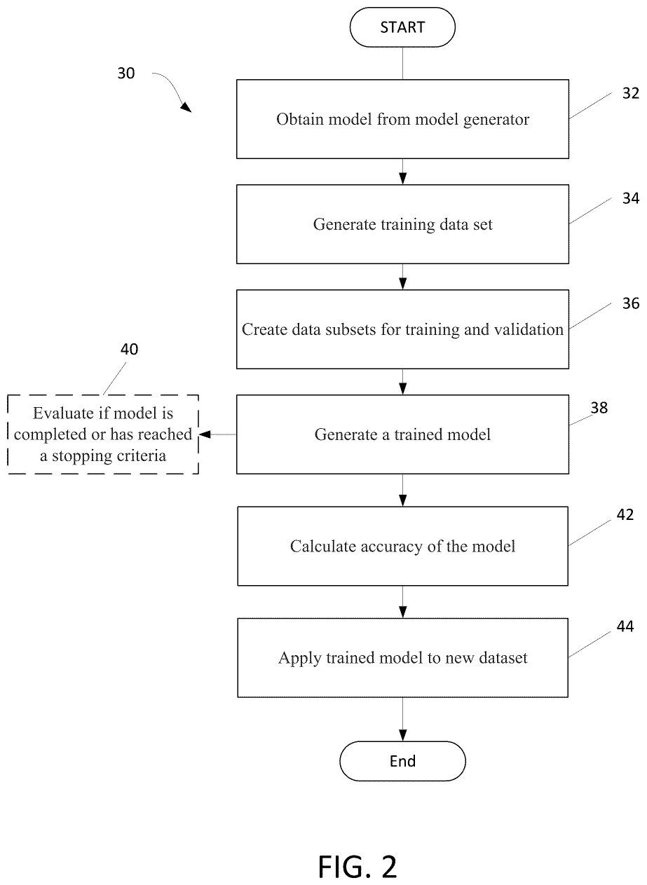

If a matching event identifier is discovered in a communication, the system processes the communication in step 26. The system processes the communication by enhancing the communication and releasing the communication or blocking the communication until reviewed by the attorney, as described in detail in FIG. 2.

The system continuously evaluates communications being transmitted through the networks of the enterprise. Importantly steps 12-26 can be performed in parallel (e.g., in a multiprocessing environment, using a plurality of processors, processing cores, processing threads, etc.) in order to review ongoing communications while processing communications. As new events are identified, new event identifiers are added to the system to be monitored in a continuous evaluation.

To ensure that the systems and methods described herein comply with one or more laws, such as privacy laws or the like, in some embodiments, employees may first consent to monitoring activities, including consent to e-mail monitoring. In a non-limiting example, consent may be company policy-based. In another non-limiting example, the employees may have provided consent as a condition of employment. In yet another non-limiting example, in embodiments where the employees are authorized users of computing devices owned and/or maintained by the enterprise, the employees may have provided consent as a condition for using the computing devices.

FIG. 2 provides a more detailed flow diagram of the various processes that may be completed to identify an event and process a communication, indicated generally at 30. At step 31, an event to be potentially monitored and/or investigated may be determined. Such a determination may generally include identifying one or more employees associated with the event, which may be an employee involved in an event that is potentially adverse to the enterprise, and/or one of each of a plurality of employees associated with the event (e.g., in instances where communications of multiple employees of an enterprise are monitored by the systems and methods described herein).

At step 32, electronic data associated with the communications may be received and monitored for matching event identifiers. The electronic data may generally be data that relates to communications transmitted by employees using computing devices and/or other network resource on the enterprise's network, including any access to external sources (e.g., the Internet) via the enterprise's computing device and/or network. Such activity may include, but is not limited to, keystrokes, clicks, electronic mail transmissions, websites visited, files that are downloaded locally onto a device, and/or the like.

If a matching event identifier is discovered in a communication in step 34, the system processes the communication in step 36. The system can process the communication by enhancing the communication in step 40 or blocking the communication in step 42 until reviewed by the attorney. The system enhances the communication in step 40 by adding the attorney to the communication as a recipient (e.g., the system adds the attorney's e-mail address to the e-mail as a recipient, the system adds the attorney's name to an electronic document as a recipient, etc.). In some embodiments, the system further enhances the communication in step 40 by adding an attorney-client disclaimer to the communication (e.g., at a top of an e-mail body or within a header or footer of an electronic document). For example, the attorney-client disclaimer may state that the communication, including attachments, is confidential and may contain information protected by the attorney-client privilege or work product doctrine.

After the communication is enhanced in step 40, the system releases the communication in step 44. In the case of an e-mail, the system saves the e-mail in the database and transmits the e-mail to the recipients, including the attorney. In the case of an electronic document, the system saves the electronic document in the database and releases the electronic document for printing, mailing, etc.

The system can further process the communication by blocking the transmission of the communication in step 42 until reviewed by the attorney. The communication is then transferred to the attorney in step 46. The attorney can review the communication to determine whether to release the communication in step 48, enhance the communication and release the communication in step 48, or temporarily or permanently block the communication. The systems and methods described herein provides a graphical user interface to the attorney for viewing and responding to the communication, which may be specifically tailored for attorney based on the attorney's role in responding to the communication. For example, in some embodiments, the graphical user interface includes a task list tab showing communications for the attorney's review. The task list may also include a subject matter, a due date, and a priority. The attorney can use the graphical user interface to select to release, enhance, and/or permanently block a communication.

In some embodiments, the systems and methods described herein utilize machine learning to analyze the communication to determine whether to enhance the communication in step 40 and release the communication in step 44 or block the communication until reviewed by the attorney in step 42. Using machine learning, the system can determine whether to release, enhance and release, or block a communication using scoring. In particular, the machine learning uses algorithms to judge various elements (e.g., event identifiers, words, sequences of words, etc.) in the communication to determine a score for the communication. The communication can be scored as no risk and can be released unenhanced, the communication can be scored as low risk and can be enhanced and released, or the communication can be scored high risk and is blocked until an attorney review is performed. For example, a communication can include a matching event identifier (e.g., a matching name) but using machine learning, the system can determine whether the communication relates to the event and should be processed, or whether the communication is unrelated to the event and can be released without being enhanced.

In some embodiments, if one or more event identifiers are discovered at step 34, an alert may be generated and transmitted to the attorney at step 50. The alert may generally be related to the event identifiers that have been detected. That is, the alert may be provided to the attorney indicating that activity was detected for an event as well as information regarding the event. The attorney may investigate and/or take corrective actions.

In step 52, all of the communications received via one or more of the steps described herein are saved in one or more databases and/or storage devices (e.g., SQL, cloud storage, HDD, etc.) and aggregated such that the communications can be accessed in a single location. In one embodiment, the original communications are saved; alternatively, in a second embodiment, the enhanced communications are saved. The communications can be used to determine past events, analyze risk, generate risk assessments, generate reports, and the like, and preserved as evidence for court. In some embodiments, the data may be aggregated into a report for an event. As such, the report includes all obtained information regarding the event as described herein. The generated report may be provided to the attorney in the user interface. In some embodiments, the system allows a user to conduct one or more searches through the communications using one or more search combinations. For example, the user can search using one or more (or combinations of) the following queries: names, telephone number, postal code, address, city, and any other suitable queries.

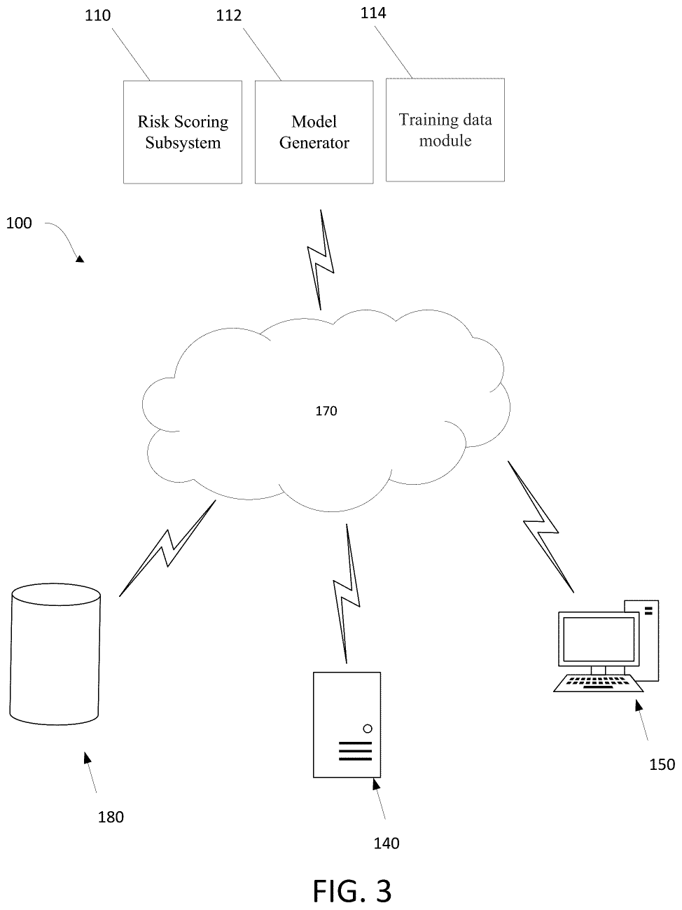

FIG. 3 is a flowchart illustrating processing steps carried out by the systems and methods of the present disclosure for processing attorney input, indicated generally at 60. In step 62, the system received input associated with the event from the attorney. The input may include, but is not limited to, uploaded documentation, relevant information such as names, dates, phone numbers, and addresses, investigations performed, investigations needed, communications received, communications reviewed, actions that have been performed, and/or actions that need to be performed relating to the event. For example, the actions may be names of individuals that have been interviewed and/or that need to be interviewed by the attorney. The systems and methods described herein may provide a user interface to the attorney for entering the input, which may be specifically tailored for attorney based on the attorney's role in entering input associated with the event. This is to ensure active participation by the attorney and to avoid “rubber stamping”.

In step 64, the system stores all input in one or more databases. For example, the input may be retained for potential court use. In some embodiments, all of the communications and/or all the input received via one or more of the steps described herein may be aggregated such that the communications and/or input can be accessed in a single location.

In step 66, a report is generated for the event. When generating the report, the communications and/or input can be used to determine past events and the like. As such, the report can include all obtained information regarding the event as described herein. The report can be displayed to the attorney in the user interface in step 68.

In some embodiments, the systems and methods described herein utilize machine learning to generate the report in step 66. The machine learning uses algorithms to analyze the communications and/or attorney input to generate a risk assessments. In particular, the machine learning is configured to assess the likelihood of risk occurrence based on the communications and/or attorney input. The system utilizes neural network software to manage the large amounts of data from the communications and analyze the potential risk factors and their characteristics and assesses each of them according to the severity. This enables the enterprise to properly act to prevent any possible harm.

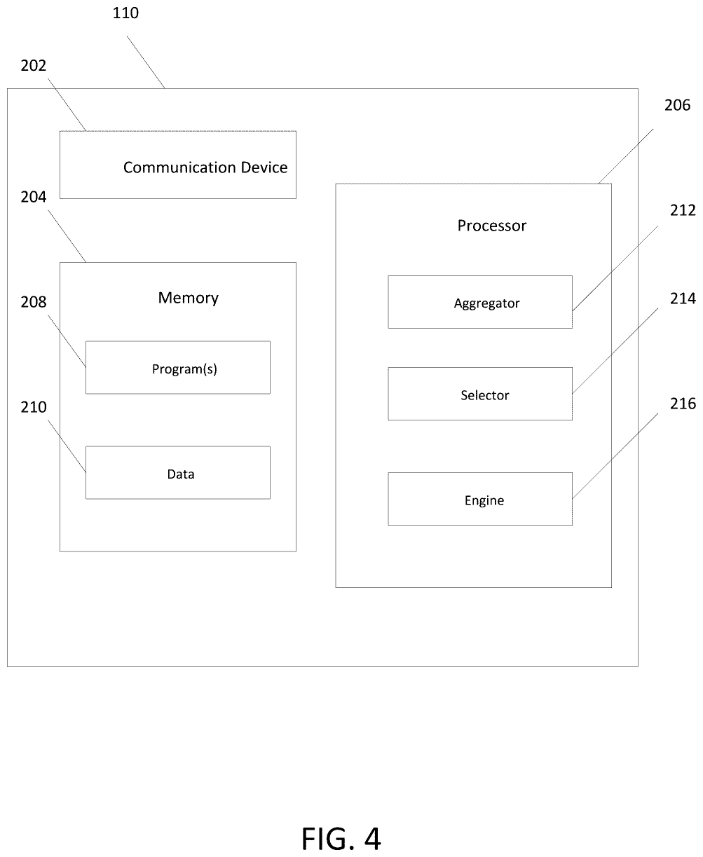

The method described with respect to FIGS. 1-3 may generally be completed by the systems described herein, including the computing network 100 described with respect to FIG. 4 and/or the various components thereof. It should be understood that the steps described herein with respect to FIGS. 1-3 may be completed for a plurality of communications at substantially the same time. As such, while the singular term “communication” may be used herein, it is meant to encompass a plurality of communications as well. In addition, the term “event” merely characterizes a particular event and it should be understood that there may be a plurality of ongoing events within an enterprise.

FIG. 4 depicts an illustrative computing network 100 that is used to automatically monitor an employee's activity and detect information that may require attorney review or attorney-client privilege, according to embodiments shown and described herein. As illustrated in FIG. 4, a computer network 110 may include a wide area network (WAN), such as the Internet, a local area network (LAN), a mobile communications network, a public service telephone network (PSTN), a personal area network (PAN), a metropolitan area network (MAN), a virtual private network (VPN), and/or another network. The computer network 110 may generally be configured to electronically connect one or more computing devices and/or components thereof. Illustrative computing devices may include, but are not limited to, one or more computing devices, such as user computing devices 120, 125, 130, 135, an attorney reviewer user computing device 140, an administrative user computing device 145, and/or one or more server computing devices, such as an application server 150, a mail transfer server 160, a communications server 170, and database servers 180, 190. Other computing devices not specifically recited should generally be understood.

The computing devices may each generally be used as an interface between a user and the other components connected to the computer network 110, and/or various other components communicatively coupled to the computing devices (such as components communicatively coupled via one or more networks to the computing devices), whether or not specifically described herein. Thus, the computing devices may be used to perform one or more functions, such as receiving one or more inputs from a user, providing information to the user, and performing actions such as interacting with electronic documents and sending and receiving e-mails. One or more of the computing devices may also be used to input additional data into a data storage portion of one or more of the server computing devices.

The various server computing devices may each receive electronic data and/or the like from one or more sources (e.g., one or more of the user computing devices and/or one or more databases), direct operation of one or more other devices (e.g., one or more of the user computing devices), contain employee communications and attorney input, and/or the like. The server computing devices and/or user computing devices are configured to capture communications transmitted by employees across one or more computer networks within the system using monitoring tools (e.g., network firewalls, router logs, network analyzers, packet-sniffers, packet-analyzers, packet capturers, applications such as e-mail monitoring software, etc.). One or more of the server computing devices and/or user computing devices are configured to enhance communications and release communications as described herein.

It should be understood that while the user computing devices are depicted as personal computers and the server computing devices are depicted as servers, these are non-limiting examples. More specifically, in some embodiments, any type of computing device (e.g., mobile computing device, personal computer, server, etc.) may be used for any of these components. Additionally, while each of these computing devices is illustrated in FIG. 4 as a single piece of hardware, this is also merely an example. More specifically, each of the user computing devices and the server computing devices may represent a plurality of computers, servers, databases, mobile devices, components, and/or the like.

In addition, it should be understood that while the embodiments depicted herein refer to a network of devices, the present disclosure is not solely limited to such a network. For example, in some embodiments, the various processes described herein may be completed by a single computing device, such as a non-networked computing device or a networked computing device that does not use the network to complete the various processes described herein.

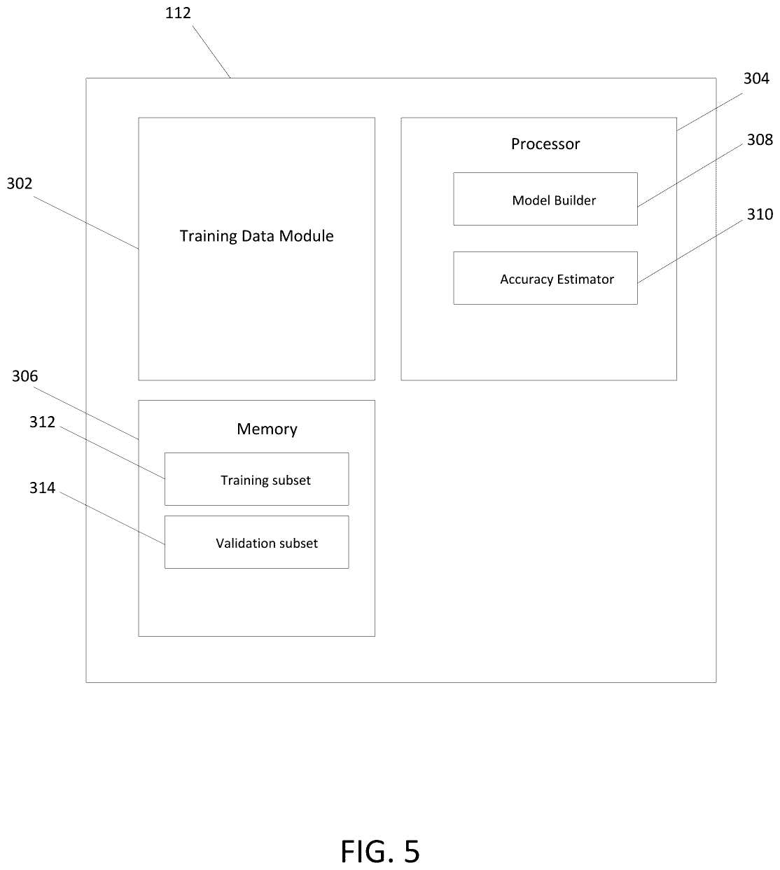

Illustrative hardware components of one of the user computing devices and/or the server computing devices are depicted in FIG. 5. A bus 200 may interconnect the various components. A processing device 205, such as a computer processing unit (CPU), may be the central processing unit of the computing device, performing calculations and logic operations required to execute a program. The processing device 205, alone or in conjunction with one or more of the other elements disclosed in FIG. 5, is an illustrative processing device, computing device, processor, or combination thereof, as such terms are used within this disclosure. Memory 210, such as read only memory (ROM) and random access memory (RAM), may constitute an illustrative memory device (e.g., a non-transitory processor—readable storage medium). Such memory 210 may include one or more programming instructions thereon that, when executed by the processing device 205, cause the processing device 205 to complete various processes, such as the processes described herein. Optionally, the program instructions may be stored on a tangible computer-readable medium such as a compact disc, a digital disk, flash memory, a memory card, a USB drive, an optical disc storage medium, such as a Blu-ray™ disc, and/or other non-transitory processor-readable storage media.

The processing device 205 could include a hardware processor such as a computer system, computer server, cloud processing service, mobile device, etc., which executes system code programmed in accordance with the processes discussed herein in connection with FIGS. 1-7. The system code could comprise non-transitory, computer-readable code stored on one or more computer-readable media capable of being accessed by the processing device 205, including, but not limited to, random-access memory (RAM), read-only memory (ROM), electrically-erasable programmable ROM (EEPROM), non-volatile (NV) memory, flash memory, disk storage, tape storage, or any other suitable memory capable of being accessed by the processing device 205. Additionally and/or alternatively, the systems and methods discussed herein could be implemented as one or more customized hardware components such as an application-specific integrated circuit (ASIC), a field-programmable gate array (FPGA), or any other suitable customized hardware component.

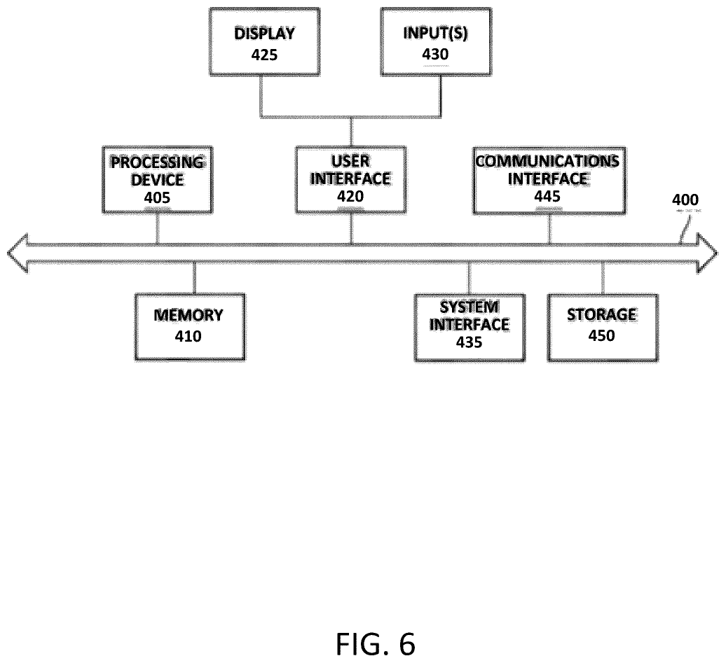

In some embodiments, the program instructions contained on the memory 210 may be embodied as a plurality of software modules, where each module provides programming instructions for completing one or more tasks. For example, as shown in FIG. 6, the memory 210 may contain operating logic 211, user interface (UI) logic 212, monitoring logic 213, artificial intelligence (AI) logic 214, and/or enhancement logic 215. These are merely illustrative examples, and alternative and/or additional logic modules may also be used to carry out the processes described herein. In addition, the various processes described herein may be completed by a combination of modules, and are not limited to a single specific module. The operating logic 211 may include an operating system and/or other software for managing components of a computing device. The UI logic 212 may include one or more software modules for providing user interfaces to users (e.g., employees, attorney, administrator, etc.). The monitoring logic 213 may include one or more software modules for monitoring and capturing employee communications, as described in greater detail herein. The AI logic 214 for performing artificial intelligence and machine learning, as described in greater detail herein. The enhancement logic 215 may include one or more software modules for enhancing communications, as described in greater detail herein.

Referring again to FIG. 5, a storage device 250, which may generally be a storage medium that is separate from the memory 210, may contain one or more data repositories for storing data associated with electronic monitoring. Electronic monitoring data may include, for example, data that is generated from electronic monitoring of an employee's activities while the employee is logged into an enterprise's networks and/or using an electronic device (such as a computing device, a mobile device, or the like) that is owned and/or maintained by an enterprise. Thus, electronic monitoring data 254 includes, but is not limited to, communications data (e.g., emails, messages, etc.), electronic documents, and, in some embodiments, attorney input. Electronic monitoring data 254 may further include, but is not limited to, browsing history, file transfer history, file editing history, voicemail data, keylogging and/or keystroke data, mouse click data, screen shot data, peripheral device access data, video monitoring data, and/or the like.

The storage device 250 may be any physical storage medium, including, but not limited to, a hard disk drive (HDD), memory, removable storage, and/or the like. While the storage device 250 is depicted as a local device, it should be understood that the storage device 250 may be a remote storage device, such as, for example, a remote server or the like.

Referring again to FIG. 5, an optional user interface 220 may permit information from the bus 200 to be displayed on a display 225 portion of the computing device in audio, visual, graphic, or alphanumeric format. Moreover, the user interface 220 may also include one or more inputs 230 that allow for transmission to and receipt of data from input devices such as a keyboard, a mouse, a joystick, a touch screen, a remote control, a pointing device, a video input device, an audio input device, a haptic feedback device, and/or the like. Such a user interface 220 may be used, for example, to allow a user to interact with the computing device or any component thereof.

In some embodiments, the user interface includes information regarding the event, including communications, event identifiers, and/or attorney input. For example, in some embodiments, an attorney can review the information to investigate the event and determine whether to release captured communications, conduct additional investigations and the like. For example, the attorney may view a captured communication in the user interface and render a decision as to an action that may or may not be taken with respect to the communication (e.g., enhance the communication, release the communication, or keep the communication blocked). It should be understood that the example provided below is merely illustrative, and alternative user interface activities may be implemented without departing from the scope of the present disclosure.

A system interface 235 may generally provide the computing device with an ability to interface with one or more of the components of the computer network 110 (FIG. 4). Communication with such components may occur using various communication ports (not shown). An illustrative communication port may be attached to a communications network, such as the Internet, an intranet, a local network, a direct connection, and/or the like.

A communications interface 245 may generally provide the computing device with an ability to interface with one or more external components, such as, for example, an external computing device, a remote server, and/or the like. Communication with external devices may occur using various communication ports. An illustrative communication port may be attached to a communications network, such as the Internet, an intranet, a local network, a direct connection, and/or the like.

It should be understood that the components illustrated m FIGS. 5-6 are merely illustrative and are not intended to limit the scope of this disclosure. More specifically, while the components in FIGS. 5-6 are illustrated as residing within one or more of the server computing devices and/or one or more of the user computing devices, these are non-limiting examples. In some embodiments, one or more of the components may reside external to the one or more server computing devices and/or the one or more user computing devices. Similarly, one or more of the components may be embodied in other computing devices not specifically described herein.

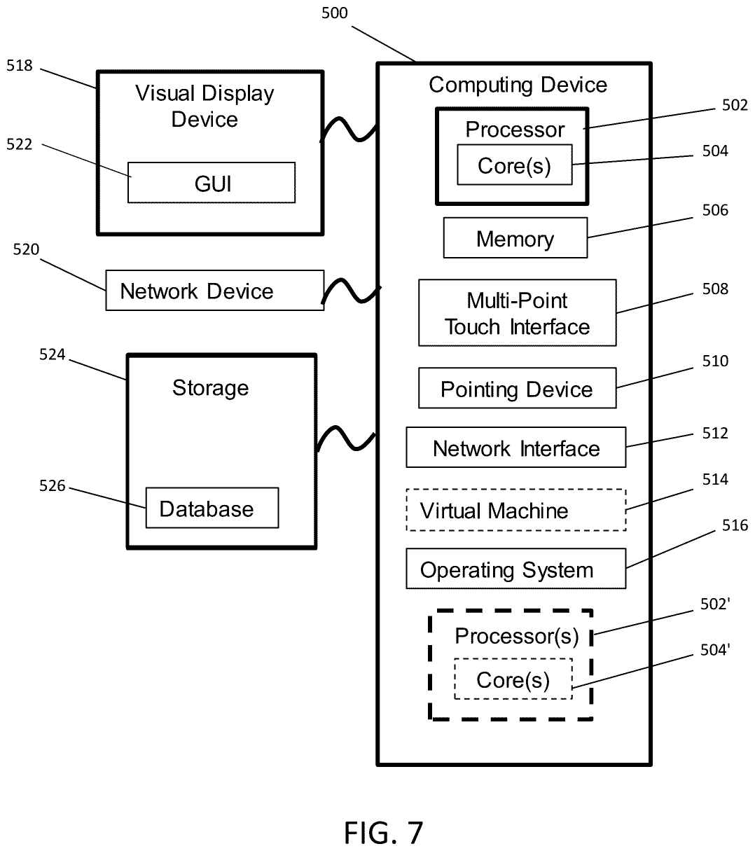

FIG. 7 is a block diagram of an exemplary computing device 300 that can be used to perform one or more steps of the methods provided by exemplary embodiments. For example, computing device 300 may be one or more of the user computing devices as described in FIG. 4. The computing device 300 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 306 included in the computing device 300 can store computer-readable and computer-executable instructions or software for implementing exemplary embodiments. The computing device 300 also includes processor 302 and associated core 304, and optionally, one or more additional processor(s) 302′ and associated core(s) 304′ (for example, in the case of computer systems having multiple processors/cores), for executing computer-readable and computer-executable instructions or software stored in the memory 306 and other programs for controlling system hardware. Processor 302 and processor(s) 302′ can each be a single core processor or multiple core (304 and 304′) processor.

Virtualization can be employed in the computing device 300 so that infrastructure and resources in the computing device can be shared dynamically. A virtual machine 314 can be provided to handle a process running on multiple processors so that the process appears to be using only one computing resource rather than multiple computing resources. Multiple virtual machines can also be used with one processor.

Memory 306 can include a computer system memory or random access memory, such as DRAM, SRAM, EDO RAM, and the like. Memory 306 can include other types of memory as well, or combinations thereof. An individual can interact with the computing device 300 through a visual display device 318, such as a touch screen display or computer monitor, which can display one or more user interfaces 322 for receiving data from the individual. The visual display device 318 can also display other aspects, elements and/or information or data associated with exemplary embodiments. The computing device 300 can include other input devices and I/O devices for receiving input from an individual, for example, a keyboard, a scanner, or another suitable multi-point touch interface 308, a pointing device 310 (e.g., a pen, stylus, mouse, or trackpad). The keyboard 308 and the pointing device 310 can be coupled to the visual display device 318. The computing device 300 can include other suitable conventional I/O peripherals.

The computing device 300 can also include one or more storage devices 324, such as a hard-drive, CD-ROM, or other computer readable media, for storing data and computer-readable instructions and/or software that implements exemplary embodiments of the system as described herein, or portions thereof, which can be executed to generate user interface 319 on display 318. Exemplary storage device 324 can also store one or more databases for storing suitable information required to implement exemplary embodiments. The databases can be updated by an individual or automatically at a suitable time to add, delete or update one or more items in the databases. Exemplary storage device 324 can store one or more databases 326 for storing data, and other data/information used to implement exemplary embodiments of the systems and methods described herein.

The computing device 300 can include a network interface 312 configured to interface via one or more network devices 322 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, processing device area network (CAN), or some combination of any or all of the above. The network interface 312 can include a built-in network adapter, network interface card, PCMCIA network card, card bus network adapter, wireless network adapter, USB network adapter, modem or another device suitable for interfacing the computing device 300 to a type of network capable of communication and performing the operations described herein. Moreover, the computing device 300 can be a computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 300 can run an operating system 316, such as versions of the Microsoft® Windows® operating systems, the different releases of the Unix and Linux operating systems, a version of the MacOS® for Macintosh computers, an embedded operating system, a real-time operating system, an open source operating system, a proprietary operating system, an operating systems for mobile computing devices, or another operating system capable of running on the computing device and performing the operations described herein. In exemplary embodiments, the operating system 316 can be run in native mode or emulated mode. In an exemplary embodiment, the operating system 316 can be run on one or more cloud machine instances.

The description is presented to enable a person skilled in the art to create and use a computer system configuration and related method and systems for an automatic detection of information requiring attorney review and/or attorney-client privilege within an enterprise. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts have been provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be provided separately or in any suitable sub-combination. Accordingly, it is submitted that the scope of protection sought herein should not be limited to the described embodiments.

What is claimed is:

1. A machine learning system for automatically detecting attorney-client privilege in enterprise data, comprising:
a processor; and
a memory in communication with the processor, the memory storing computer-readable instructions which, when executed by the processor, cause the processor to:
capture an electronic communication transmitted across one or more computer networks in communication with the processor;
process the electronic communication to search for a name or an e-mail address matching at least one pre-defined event identifier;
detect whether the at least one pre-defined event identifier exists in the electronic communication;
if the at least one pre-defined event identifier is not detected in the electronic communication, release the electronic communication to a recipient on the one or more computer networks; and
if the at least one pre-defined event identifier is detected in the electronic communication, perform the steps of either: (1) enhancing and releasing the communication, or (2) blocking the electronic communication from being transmitted to a recipient.

2. The system of claim 1, wherein processor captures the electronic communications using one or more of a network firewall, a network analyzer, a packet sniffer, a packet capturer, e-mail monitoring software, or a filter.

3. The system of claim 1, wherein the processor searches for the name or the e-mail address using a matching algorithm or a machine learning algorithm.

4. The system of claim 1, wherein the processor obtains at least one consent from a user of the one or more computer networks prior to capturing the electronic communication.

5. The system of claim 1, wherein the electronic communication comprises one or more of a keystroke, a click, an electronic mail transmission, a website access, or a file download.

6. The system of claim 1, wherein the processor enhances the communication by adding an attorney as a recipient of the electronic communication.

7. The system of claim 1, wherein the processor enhances the communication by adding an attorney-client disclaimer to the electronic communication.

8. The system of claim 1, wherein after blocking the electronic communication, the processor transmits the electronic communication to an attorney for review.

9. The system of claim 8, wherein the processor generates a graphical user interface for allowing the attorney to review the electronic communication.

10. The system of claim 8, wherein the electronic communication is released to the recipient by the processor after the attorney reviews the electronic communication.

11. The system of claim 1, wherein after blocking the electronic communication, the processor processes the electronic communication using a machine learning algorithm to score the electronic communication.

12. A machine learning method for automatically detecting attorney-client privilege in enterprise data, comprising:
capturing by a processor an electronic communication transmitted across one or more computer networks in communication with the processor;
processing the electronic communication to search for a name or an e-mail address matching at least one pre-defined event identifier;
detecting whether the at least one pre-defined event identifier exists in the electronic communication;
if the at least one pre-defined event identifier is not detected in the electronic communication, releasing the electronic communication to a recipient on the one or more computer networks; and
if the at least one pre-defined event identifier is detected in the electronic communication, performing the steps of either: (1) enhancing and releasing the communication, or (2) blocking the electronic communication from being transmitted to a recipient.

13. The method of claim 12, wherein capturing the electronic communication includes utilizing one or more of a network firewall, a network analyzer, a packet sniffer, a packet capturer, e-mail monitoring software, or a filter.

14. The method of claim 12, further comprising searching for the name or the e-mail address using a matching algorithm or a machine learning algorithm.

15. The method of claim 12, further comprising obtaining at least one consent from a user of the one or more computer networks prior to capturing the electronic communication.

16. The method of claim 12, wherein the electronic communication comprises one or more of a keystroke, a click, an electronic mail transmission, a website access, or a file download.

17. The method of claim 12, further comprising enhancing the communication by adding an attorney as a recipient of the electronic communication.

18. The method of claim 12, further comprising enhancing the communication by adding an attorney-client disclaimer to the electronic communication.

19. The method of claim 12, further comprising transmitting the electronic communication to an attorney for review.

20. The method of claim 19, further comprising generating a graphical user interface for allowing the attorney to review the electronic communication.

21. The method of claim 19, further comprising releasing the electronic communication to the recipient after the attorney reviews the electronic communication.

22. The method of claim 12, further comprising processing the electronic communication using a machine learning algorithm to score the electronic communication.
